(19) United States
(12) Patent Application Publication
(10) Pub. No.: US 2025/0278531 A1
(43) Pub. Date: Sep. 4, 2025

(54) TOOLING MODEL CREATION DEVICE, TOOLING MODEL CREATION METHOD, AND PROGRAM

(71) Applicant: MITSUBISHI HEAVY INDUSTRIES, LTD., Tokyo (JP)

(72) Inventors: Jun ETO, Tokyo (JP); Satoshi NAKASHIMA, Tokyo (JP); Sachio TAKEYAMA, Tokyo (JP); Kazuhiro TOMINAGA, Tokyo (JP); Taizo YAMAKADO, Tokyo (JP); Koji TOMIDA, Tokyo (JP); Ryota GOTO, Tokyo (JP)

(21) Appl. No.: 19/014,225

(22) Filed: Jan. 9, 2025

(30) Foreign Application Priority Data
Mar. 1, 2024 (JP) 2024-031583

(51) Int. Cl. G06F 30/15; G06F 113/28

(52) U.S. Cl. CPC G06F 30/15; G06F 2113/28

(57) ABSTRACT

A tooling model creation device includes a unit configured to create, based on an engineering model that is design information on a completed aircraft body of an aircraft, a layout model including design information on a piece of tooling necessary for manufacturing the aircraft body, and a unit configured to extract the design information on the piece of tooling from the layout model and create a manufacturing drawing model in which information necessary for manufacturing the piece of tooling is added to the design information on the piece of tooling.

### CROSS-REFERENCE TO RELATED APPLICATIONS

This application claims the benefit of priority to Japanese Patent Application Number 2024-031583 filed on Mar. 1, 2024. The entire contents of the above-identified application are hereby incorporated by reference.

### TECHNICAL FIELD

The disclosure relates to a tooling model creation device, a tooling model creation method, and a program for tooling.

### RELATED ART

In aircraft manufacture, small components having a length of approximately 100 mm to large components having a length of more than 10 m are handled for weight reduction and structural optimization. The respective components have different shapes, and some components have complicated shapes. Thus, a large number of pieces of tooling are necessary for manufacturing and inspecting structural components of an aircraft. In contrast, an aircraft structure is a semi-monocoque structure, and a structural strength is ensured while divided structures are gradually assembled. For example, in an assembly process, non-rigid components are drilled and coupled with a bolt or fastener to form a rigid body. In this case, in order for the accuracy of the outer shape of an aircraft body to be ensured, a large number of pieces of large-scale tooling are used. Further, in most cases, additional processing is performed on a component in each assembly process until a final assembled body is obtained, and thus dedicated processing tooling is also necessary in each process. In this way, a large number of pieces of large and small tooling for various purposes are used in processes of manufacturing and assembling components of an aircraft. In an aircraft development process, accuracy is gradually increased from initial design to a final drawing. The specification of an aircraft body defined by design is one in a state of a final assembled body, and the specification of each assembly process and each single component need to be broken down in consideration of a manufacturing process. Thus, the accuracy of tooling design is also gradually increased in accordance with aircraft body design. In aircraft manufacture, efficient design and manufacture techniques for tooling are demanded for reduction of a development lead time. In order to shorten the development lead time, it is common to start the above-described tooling design from an initial design stage. Further, in order to rapidly manufacture a first aircraft after completion of aircraft body design, it is necessary to proceed with arrangement of tooling before completion of the tooling design.

JP 2018-36899 A discloses a method for creating a manufacturing Bill Of Materials (BOM). In this method, the manufacturing BOM is created from a design BOM in the middle of product design, and thus it is possible to proceed with subcontract arrangement, unit manufacture, and the like related to product manufacture before completion of the design. The technology described in JP 2018-36899 A does not relate to BOM creation of aircraft tooling.

### SUMMARY

Provided is a technology capable of efficiently designing and manufacturing tooling in conjunction with aircraft body design of an aircraft.

The disclosure provides a tooling model creation device, a tooling model creation method, and a program that are capable of solving the above-described problem.

A tooling model creation device according to the disclosure includes a unit configured to create, based on an engineering model that is design information on a completed aircraft body of an aircraft, a layout model including design information on a piece of tooling necessary for manufacturing the aircraft body, and a unit configured to extract the design information on the piece of tooling from the layout model and create a manufacturing drawing model in which information necessary for manufacturing the piece of tooling is added to the design information on the piece of tooling.

A tooling model creation method according to the disclosure includes creating, based on an engineering model that is design information on a completed aircraft body of an aircraft, a layout model including design information on a piece of tooling necessary for manufacturing the aircraft body, and extracting the design information on the piece of tooling from the layout model and creating a manufacturing drawing model in which information necessary for manufacturing the piece of tooling is added to the design information on the piece of tooling.

A program according to the disclosure causes a computer to execute creating, based on an engineering model that is design information on a completed aircraft body of an aircraft, a layout model including design information on a piece of tooling necessary for manufacturing the aircraft body, and extracting the design information on the piece of tooling from the layout model and creating a manufacturing drawing model in which information necessary for manufacturing the piece of tooling is added to the design information on the piece of tooling.

According to the tooling model creation device, the tooling model creation method, and the program of the disclosure, it is possible to efficiently design and manufacture tooling in conjunction with aircraft body design of an aircraft.

### BRIEF DESCRIPTION OF DRAWINGS

The disclosure will be described with reference to the accompanying drawings, wherein like numbers reference like elements.

FIG. 1 is a block diagram illustrating an example of a tooling model creation device according to an embodiment.

FIG. 2 is a diagram illustrating an outline of a process of creating each model according to the embodiment.

FIG. 3A is a first diagram illustrating an example of an external appearance of a part of an aircraft body and tooling according to the embodiment.

FIG. 3B is a second diagram illustrating the example of the external appearance of the part of the aircraft body and the tooling according to the embodiment.

FIG. 3C is a third diagram illustrating the example of the external appearance of the part of the aircraft body and the tooling according to the embodiment.

FIG. 4A is a first diagram illustrating an example of details of the part of the aircraft body and the tooling according to the embodiment.

FIG. 4B is a second diagram illustrating the example of the details of the part of the aircraft body and the tooling according to the embodiment.

FIG. 4C is a third diagram illustrating the example of the details of the part of the aircraft body and the tooling according to the embodiment.

FIG. 5 is a diagram illustrating an outline of a tree configuration included in each model according to the embodiment.

FIG. 6A is a first diagram illustrating an example of each model before change according to the embodiment.

FIG. 6B is a second diagram illustrating the example of each model before the change according to the embodiment.

FIG. 7A is a first diagram for describing BOM creation according to the embodiment.

FIG. 7B is a second diagram for describing the BOM creation according to the embodiment.

FIG. 7C is a first diagram for describing captures according to the embodiment.

FIGS. 7D(a) and 7D(b) are second diagrams for describing the captures according to the embodiment.

FIG. 8 is a diagram illustrating an example of an operation of the tooling model creation device according to the embodiment.

FIG. 9 is a diagram illustrating an example of a hardware configuration of the tooling model creation device according to the embodiment.

### DESCRIPTION OF EMBODIMENTS

### Embodiments

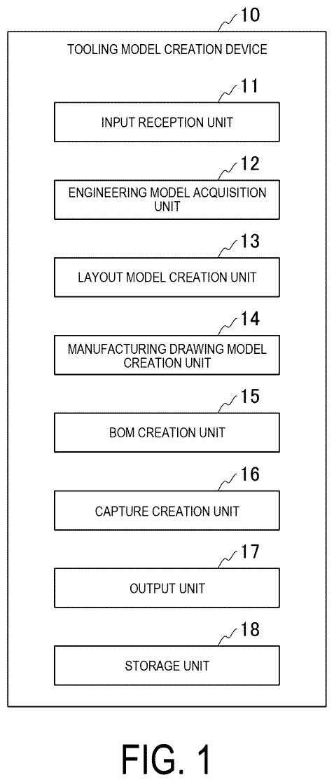

Hereinafter, a method for creating a tooling model for an aircraft according to the disclosure will be described with reference to FIGS. 1 to 9.

### Configuration

FIG. 1 is a block diagram illustrating an example of a tooling model creation device according to an embodiment.

A tooling model creation device 10 is configured of one or more computers. As illustrated in the drawing, the tooling model creation device 10 includes an input reception unit 11, an engineering model acquisition unit 12, a layout model creation unit 13, a manufacturing drawing model creation unit 14, a BOM creation unit 15, a capture creation unit 16, an output unit 17, and a storage unit 18. The layout model creation unit 13 and the manufacturing drawing model creation unit 14 are configured to include, for example, CAD software.

The input reception unit 11 receives various types of information input by using an input device such as a keyboard, a mouse, a touch panel, or a button, instruction information for instructing start and end of processing, and the like. For example, the input reception unit 11 receives various types of information related to tooling for aircraft manufacture (for example, a name, an identification number, a type, a weight, a quantity, a component constituting the tooling, a material, a shape, processing or an assembling method, and the like), which are input to the tooling model creation device 10. In addition, the input reception unit 11 receives settings of links between an engineering model, a layout model, and a manufacturing drawing model, which will be described below. Examples of each link include a setting performed when it is desired that a part of the configuration of the engineering model and a part of the configuration of the layout model be associated with each other and that pieces of design information on the associated parts be linked or work in conjunction with each other. By setting the link, when the configuration of the engineering model is changed, the change can be automatically reflected in the associated configuration of the layout model. As one form of the link, link-copy (described below) may be used in the present embodiment.

The engineering model acquisition unit 12 acquires an engineering model that is created by a designer and that represents a packing style of an aircraft body after final assembly of an aircraft. The engineering model includes, in addition to three-dimensional model information indicating the shape of the aircraft at the time of completion, coupling information such as fasteners and bolts as assembly information, positioning information by shims and sealants, and the like. The engineering model is modified and information is added thereto in accordance with a design phase in each stage from initial design to a final drawing.

The layout model creation unit 13 creates, based on an instruction from a tooling designer, a layout model that is design data of tooling necessary for manufacturing the aircraft body, and adds the layout model to a part of the engineering model where the tooling is to be used. The layout model is a model that defines the shape and structure of the tooling by being linked with the engineering model and a production facility model. The tooling designer link-copies necessary elements (for example, reference standards such as an aircraft body surface, a reference surface, and a reference hole) from the engineering model to define the shape and position of the tooling. The layout model creation unit 13 creates data obtained by link-copying the engineering model and adds the defined tooling shape and the like to the created data to create the layout model. When the design of the engineering model is changed, information in the layout model, which is link-copied from the engineering model, is automatically updated. Link-copy is, for example, a function included in the CAD software, and is a function by which when the position or size of a certain element A (for example, aircraft fuselage panel) is changed in the engineering model, the changed content is automatically reflected in an element A in link-copy destination data. By using this function, when the engineering model is changed, the contents of the change can be automatically reflected in the layout model. The link-copy function is not limited to a function included in the CAD software. For example, there may be a function implemented by which an identification number of an element A in link-copy destination data and an identification number of an element A in a copy source engineering model are managed in association with each other, and when a change is made to the element A in the engineering model, the change made to the engineering model is reflected in the element A having the corresponding identification number in the link-copy destination data in the layout model. In addition, the layout model creation unit 13 sets a link between predetermined pieces of design information in the layout model, and, when the engineering model is changed, updates all pieces of tooling design information affected by the change.

The manufacturing drawing model creation unit 14 extracts only information on the tooling from the layout model based on an instruction from the tooling designer, performs link-copy, further adds more specific information necessary for manufacturing the tooling (information such as a name, a model number, a quantity, a weight, and a processing method of a component constituting the tooling), and creates a manufacturing drawing model of the tooling. The manufacturing drawing model is a model in which tooling configuration data is link-copied from the layout model and organized in a tree. The manufacturing drawing model can be used for tooling manufacture, production simulation, checking work using virtual reality (VR), and the like. In the manufacturing drawing model, a configuration model for manufacture, an instruction manual (also referred to as a manual) for describing how to use the manufactured tooling at the manufacturing site of the aircraft body, and inspection data necessary for inspecting the tooling are separately defined. The inspection data is used as a reference for maintaining the accuracy of the tooling, and includes a measurement surface and coordinates. The manufacturing drawing model is small-sized data that does not include information on design know-how such as design history information on the engineering model and the tooling model and that is obtained by extracting only information necessary for manufacturing and inspecting the tooling. The manufacturing drawing model is given to, for example, a tooling manufacturer or the like. However, the manufacturing drawing model is separated from the engineering model and the layout model and is specialized in only information necessary for manufacturing the tooling, which can prevent leakage of confidential design information, design know-how, and the like. Further, the data has a small size and thus is easy to handle at the time of use in production simulation and VR.

The BOM creation unit 15 creates a Bill Of Materials (BOM) that is list information on a component and the like necessary for manufacturing the tooling from the manufacturing drawing model.

The capture creation unit 16 creates a capture registered in the manufacturing drawing model. The capture includes various technical instructions such as a shape, a specification, a geometric dimensional tolerance, and processing instructions about welding, surface treatment, and the like, with respect to a single component or an assembled part constituting the tooling. The output unit 17 outputs the engineering model, the layout model, the manufacturing drawing model, the BOM, and the like, to a display device, an electronic file, or the like.

The storage unit 18 stores the engineering model, the layout model, the manufacturing drawing model, and the like.

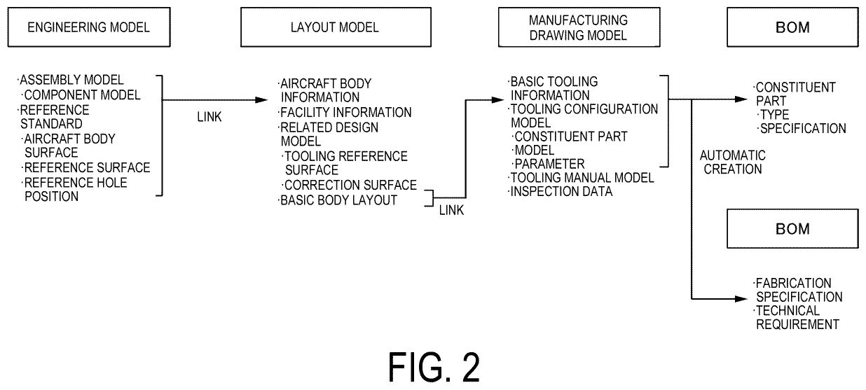

FIG. 2 illustrates an outline of a process of creating a manufacturing drawing model, and the like. First, an engineering model is created using the CAD software. The engineering model includes an assembly model (by what component an assembly is constituted), a component model of each component (a type, a size, and the like of the component), and reference standards such as an aircraft body surface, a reference surface (a surface serving as a reference when the component is disposed), and a reference hole position. The engineering model is used for type certification or the like. After the engineering model is created, a layout model is created without waiting for the completion of the release of an aircraft body drawing. The layout model is created by link-copying necessary information from the engineering model.

The layout model includes aircraft body information, facility information, a related design model, a tooling reference surface, a correction surface, a basic layout, and the like. After the layout model is created, the tooling designer examines and designs in detail tooling on the layout model using the CAD software. As a result, the layout model includes rough design information on the tooling. A manufacturing drawing model is created by link-copying design data of the tooling designed in the layout model. At this time, the manufacturing drawing model is created by excluding history information on the layout model and extracting only final solid design data. The layout model and the manufacturing drawing model defining information for manufacturing the tooling are separately created while partly linked with each other. The layout model includes not only the design information on the tooling but also the aircraft body information, the facility information, and the like. In contrast, the manufacturing drawing model includes only information necessary for manufacturing and inspecting the tooling. Thus, it is possible to prevent leakage of the aircraft body information and design know-how to a tooling manufacturer, an overseas manufacturer, and the like.

The manufacturing drawing model includes information such as basic tooling information, a tooling configuration model, a constituent part, a model, a parameter, and a tooling manual model. The tooling designer also defines BOM information on a model basis while creating a tree configuration of the manufacturing drawing model using the CAD software. In the basic tooling information, a tooling specification, a note, a processing instruction about the entire tooling, a part of the aircraft body where the tooling is to be used, and the like are defined on a model (for example, a three-dimensional CAD model). In the tooling configuration model, necessary information (shape, specification, quantity, position, and the like) is defined using a model or a parameter according to a design phase or the type of a tooling constituent part, and a BOM and a capture are directly created from the tooling configuration model. A constituent part includes an assembled part, a fabricated part, and a purchased part/standard part. The assembled part is further classified into a coupled part assembled by being joined with a bolt or the like, a welded part assembled by being joined by welding, and the like. The purchased part/standard part is classified into a part requiring additional processing and a part requiring no additional processing. For the assembled part and the fabricated part that require manufacture, the position and shape are defined on a model, and specifications (quantity, material size, and the like) are defined using the model and a parameter. For the purchased part/standard part that do not require modeling, a model number and a quantity are defined using only a parameter. However, a model is created for a purchased part/standard part that requires interference check, placement instruction, and additional processing. When the engineering model or the layout model is changed, the manufacturing drawing model is automatically updated through the links. A method of defining the component specification in the manufacturing drawing model is changed according to the design phase in each stage from the initial design to final drawing and the type of a tooling constituent part. Thus, the BOM and the capture according to the design phase can be automatically created.

The BOM includes the type, quantity, and specification of a constituent part. The capture includes fabrication specifications and technical requirements related to the tooling and a component constituting the tooling. The shape and specification definition are updated according to the design phase in each stage, and the BOM is automatically created each time. Thus, the tooling can be manufactured (arranged, assembled, and inspected) in parallel with the tooling design. In addition, by automatically creating the capture each time the design is changed, work instruction information for manufacturing and inspecting the tooling can be updated.

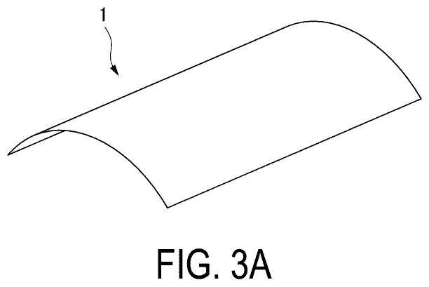

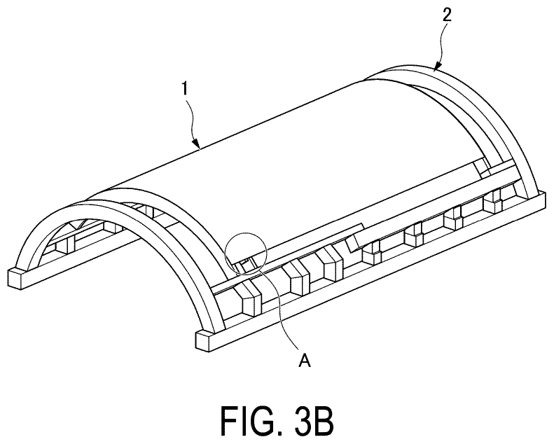

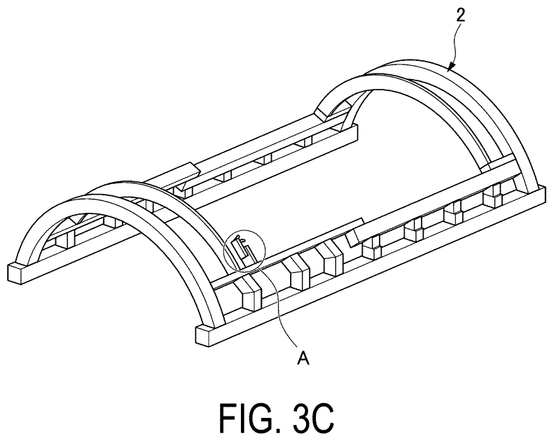

FIGS. 3A to 3C illustrate an example of an external appearance of a component constituting the aircraft body and tooling necessary for manufacturing the component. FIG. 3A illustrates an aircraft fuselage panel 1 as an example of the engineering model. An aircraft designer designs the aircraft fuselage panel 1. The engineering model acquisition unit 12 acquires the engineering model illustrated in FIG. 3A. Next, based on an instruction from a tooling designer, the layout model creation unit 13 creates a layout model by link-copying the engineering model. Based on the aircraft fuselage panel 1 included in the created layout model, the tooling designer designs a piece of aircraft fuselage panel assembly tooling 2 necessary for manufacturing the aircraft fuselage panel 1. The layout model creation unit 13 adds the design data of the aircraft fuselage panel assembly tooling 2 to the layout model based on the design by the tooling designer. FIG. 3B illustrates an example of the layout model created by the layout model creation unit 13. The layout model in FIG. 3B includes the aircraft fuselage panel 1 and the aircraft fuselage panel assembly tooling 2. FIG. 3C illustrates a three-dimensional model of the aircraft fuselage panel assembly tooling 2.

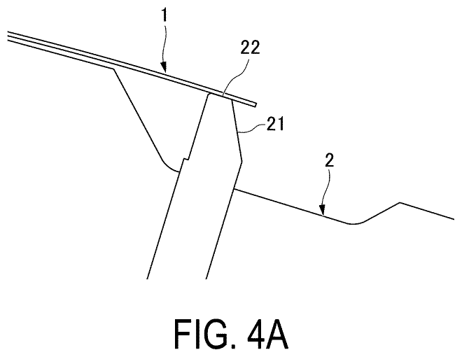

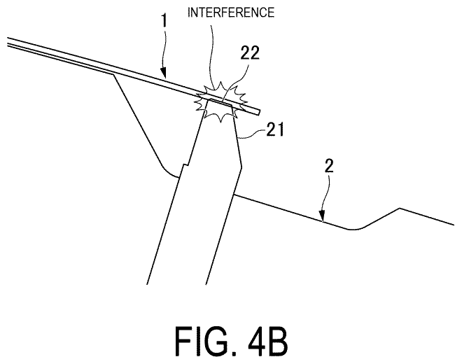

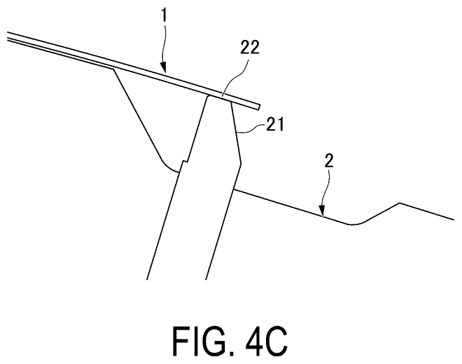

FIGS. 4A to 4C illustrate a layout model of a part indicated by “A” in FIGS. 3B and 3C. FIG. 4A illustrates the layout model of the part “A” before the engineering model is changed. In FIG. 4A, the aircraft fuselage panel 1 and an end face 22 of a locator 21 of the aircraft fuselage panel assembly tooling 2 are in contact with each other. Next, it is assumed that the design of the engineering model is changed and that the position of the aircraft fuselage panel 1 is changed. Here, when the aircraft fuselage panel 1 of the layout model is created by being link-copied from the aircraft fuselage panel 1 of the engineering model, the design change of the aircraft fuselage panel 1 is automatically reflected in the layout model. FIG. 4B illustrates an example of the layout model after the design change of the aircraft fuselage panel 1. As illustrated in the drawing, since the design change is made to the position of the aircraft fuselage panel 1, the aircraft fuselage panel 1 and the locator 21 interfere with each other in FIG. 4B. The tooling designer corrects the position of the locator 21 with reference to FIG. 4B. Alternatively, when the layout model is created, a position where the end face 22 of the locator 21 does not interfere with the aircraft fuselage panel 1 is set as the position of the end face 22 (setting of a link) in association with the position of the aircraft fuselage panel 1. Thus, when the design of the aircraft fuselage panel 1 is changed, the layout model can be changed so that the position of the locator 21 is automatically adjusted to the position illustrated in FIG. 4C. Next, how the process of the design change illustrated in FIGS. 4A to 4C is automated through the links set in the layout model and the manufacturing drawing model will be described.

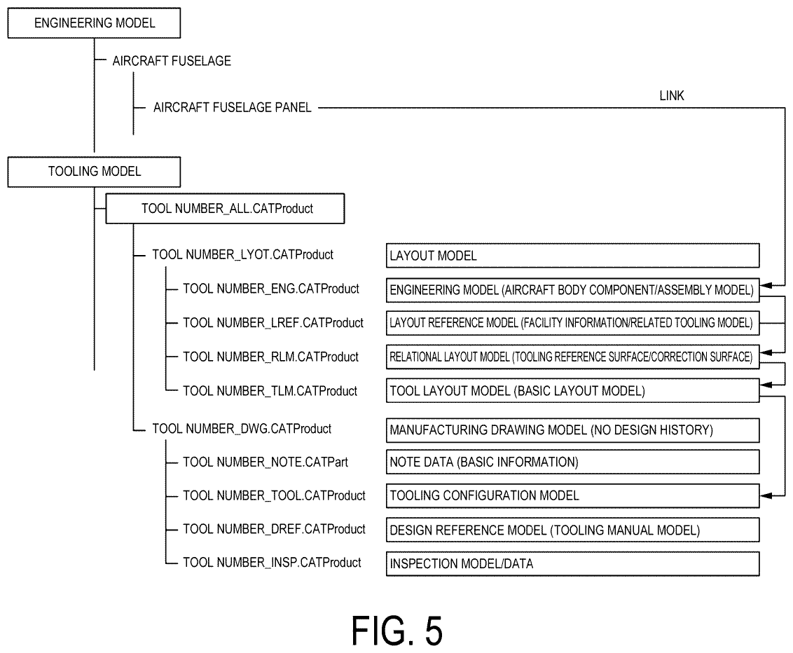

FIG. 5 illustrates an example of a tree configuration of each of the engineering model, the layout model, and the manufacturing drawing model. The tooling model includes the layout model (tree subordinate to LYOT.CATProduct) and the manufacturing drawing model (tree subordinate to DWG.CATProduct). Note that “CATProduct” of LYOT.CATProduct and DWG.CATProduct and “CATPart” of NOTE. CATPart and the like appearing in the following description indicate that they are files of CATIA (trade name), which is CAD software. In the description of the present embodiment, a case where CATIA (trade name) is used as an example will be described. However, the used software is not limited to CATIA (trade name), and other CAD software may be used, and the functions of the present embodiment may be implemented using software other than CAD software. The tree configuration of the engineering model in FIG. 5 is information that can be set on the same screen while the three-dimensional model illustrated in FIG. 3A is displayed. Similarly, the tree configuration of the layout model illustrated in FIG. 5 is information that can be set on the same screen while the three-dimensional model of the layout model is displayed, and the tree configuration of the manufacturing drawing model illustrated in FIG. 5 is information that can be set on the same screen while the three-dimensional model of the manufacturing drawing model is displayed. Each of the engineering model, the layout model, and the manufacturing drawing model includes both the three-dimensional model and the tree configuration.

As illustrated in the drawing, the layout model (LYOT.CATProduct) includes an engineering model (ENG.CATProduct), facility information/related tooling model (LREF.CATProduct), a related design model (RLM.CATProduct), and a basic layout model (TLM.CATProduct). The engineering model includes an assembly model and the like of an aircraft body part related to tooling link-copied from the engineering model. The facility information/related tooling model includes related data necessary for designing the tooling (facility information such as a machine tool, a tool, and a factory for manufacturing the tooling, information on related tooling, and the like). In the related design model, the relationship (positional relationship and the like) between the engineering model and the tooling model, a tooling reference surface, a correction surface, and the like are defined. In the basic layout model, the basic shape and the like of the tooling are defined. The tooling designer designs the tooling mainly by creating the basic layout model.

The manufacturing drawing model (DWG.CATProduct) includes basic tooling information (NOTE.CATPart), a tooling configuration model (TOOL.CATProduct), a tooling manual model (DREF.CATProduct), and an inspection/checkup model (INSP.CATProduct). The basic tooling information includes basic information such as a tooling specification and a note. The tooling configuration model includes data necessary for manufacturing the tooling. The tooling manual model includes data representing an assembly drawing of the tooling. The inspection/checkup model includes data necessary for inspecting the tooling.

FIG. 5 illustrates links between the tree configurations of the models. A link is established between the aircraft fuselage panel of the engineering model and the engineering model of the layout model. The link indicates a relationship in which when there is a change in a link source, the change is also reflected in a link destination, and the link-copy is an example thereof. When the link is set, and, for example, information on the link source is changed from information 1 to information 2, information on the link destination is also changed from information 1 to information 2. Alternatively, when the link is set, information on the link source (for example, position information) and information on the link destination have a certain relationship, and the information on the link source is updated, the information on the link destination is also updated while the certain relationship with the link source is maintained. The tooling designer can freely define the relationship between the link source and the link destination. For example, the aircraft fuselage panel in the engineering model of FIG. 5 is the link source, and the engineering model of the layout model is the link destination. This link is set by link-copying. Similarly, links are set between the engineering model (link source) of the layout model and the related design model (link destination) of the layout model, between the facility information/related tooling model (link source) of the layout model and the related design model (link destination) of the layout model, between the related design model (link source) of the layout model and the basic layout model (link destination) of the layout model, and between the basic layout model (link source) of the layout model and the tooling configuration model (link destination) of the manufacturing drawing model. For example, in the case of the link between the engineering model and the related design model of the layout model, the surface of the aircraft fuselage panel 1 on the locator 21 side (FIG. 4A) and the tooling reference surface (the surface serving as the reference for disposing the tooling) are linked and set so as to have a certain positional relationship. Moreover, in the basic layout model, the position of the end face 22 of the locator 21 is set with reference to the tooling reference surface.

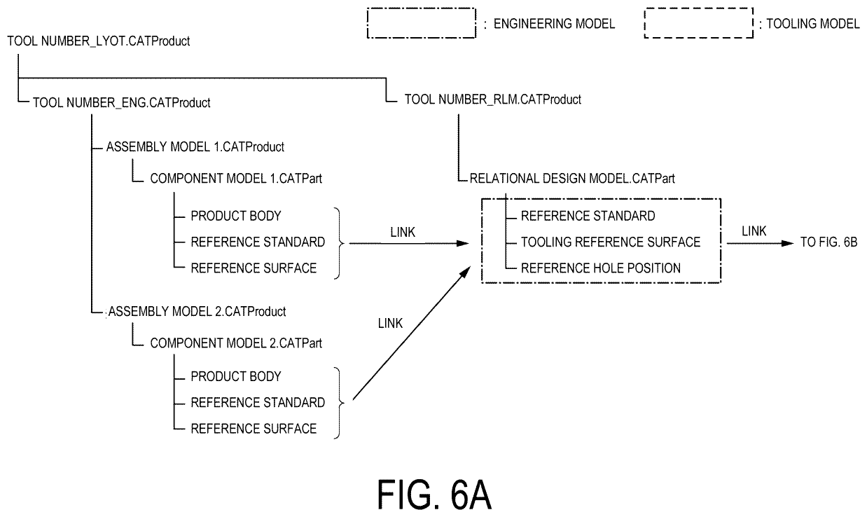

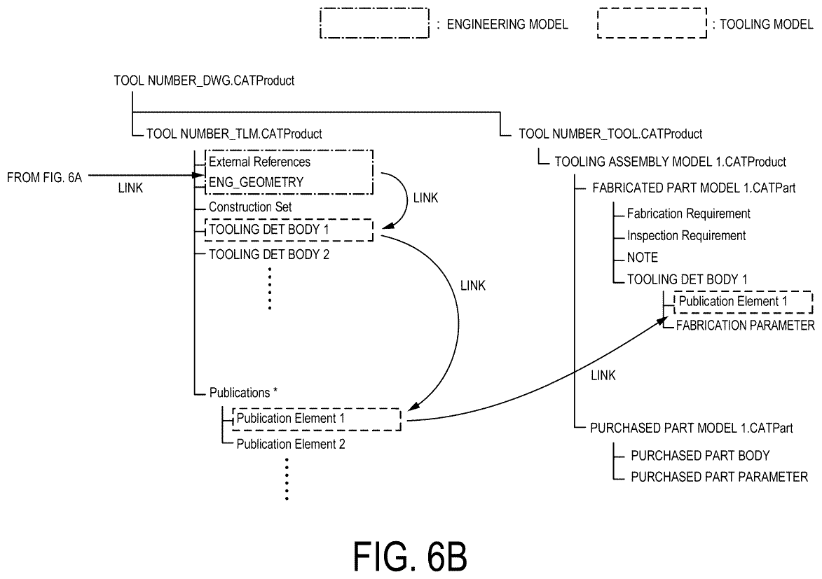

On the premise of these links, the process from FIGS. 4A to 4C will be described from the viewpoint of the tree configurations. FIGS. 6A and 6B illustrate the tree configuration related to the layout model and the tree configuration related to the manufacturing drawing model. When only the engineering model is changed in a situation where there is such a link relationship, the tooling model is not updated, which brings about a state in which interference illustrated in FIG. 4B occurs. Next, when model update is performed based on the links in the layout model, the change in the engineering model is reflected in the engineering model (ENG.CATProduct) of the layout model, the change in the engineering model (ENG.CATProduct) is reflected in the related design model (RLM.CATProduct), and the change in the related design model (RLM.CATProduct) is reflected in the basic layout model (TLM.CATProduct). At this time, when the aircraft fuselage panel 1 and the tooling reference surface are set to have a certain positional relationship through the links between the engineering model and the related design model (RLM.CATProduct) of the layout model, the change in the position of the aircraft fuselage panel 1 in the engineering model is reflected in the tooling reference surface, and the tooling reference surface also moves in accordance with the position of the aircraft fuselage panel 1. Accordingly, the position of the locator 21 located with reference to the tooling reference surface is also corrected. Next, when model update is performed based on the links in the manufacturing drawing model, the change in the basic layout model (TLM.CATProduct) of the layout model is reflected in the tooling configuration model (TOOL.CATProduct) of the manufacturing drawing model. The change in the basic layout model is similarly reflected in linked elements of the tooling manual model (DREF.CATProduct) and the inspection/checkup model (INSP.CATProduct). By appropriately setting the links in this way, even when the position of the aircraft fuselage panel 1 is changed in the engineering model, the link function allows the layout model to be obtained in which the position of the locator 21 is automatically adjusted to a position corresponding to the changed position of the aircraft fuselage panel 1, and the link function allows reduction of design work for following the change in the engineering model and reduction of time and effort necessary for the work.

A method of updating the linked information in the layout model and the manufacturing drawing model is freely determined. For example, a configuration may be adopted in which when a file storing the layout model or the manufacturing drawing model is opened using the CAD software, the file may be automatically updated with reference to link source data. Otherwise, a configuration may be adopted in which a file storing the layout model or the manufacturing drawing model is opened using the CAD software and an operation such as pressing a link update button is performed, so that a change in link source data may be reflected. The change in the engineering model is reflected in the layout model by following the links in this way, and thus the layout model illustrated in FIG. 4C can be automatically obtained. In addition, the manufacturing drawing model (not illustrated) corresponding to FIG. 4C can be automatically obtained. Thus, every time the design model is changed in accordance with a design phase from the initial design to final drawing, the change can be automatically reflected in the layout model for designing the tooling and the manufacturing drawing model for manufacturing the tooling.

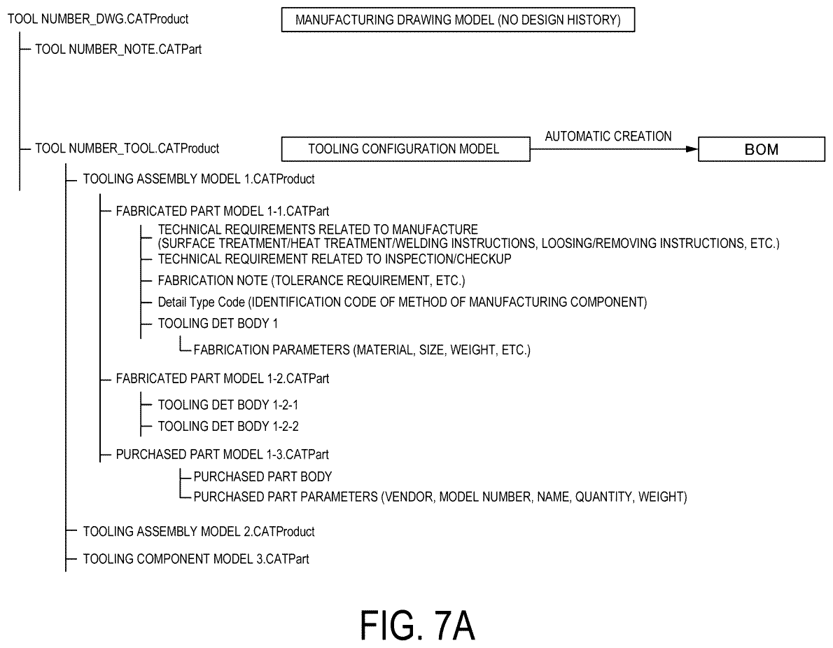

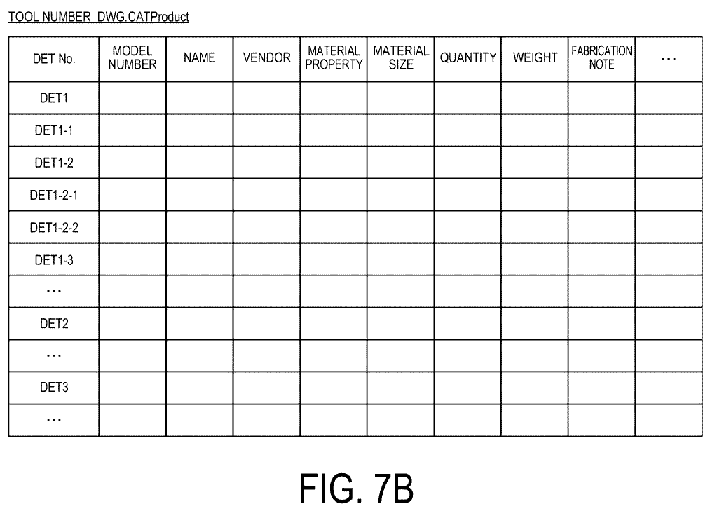

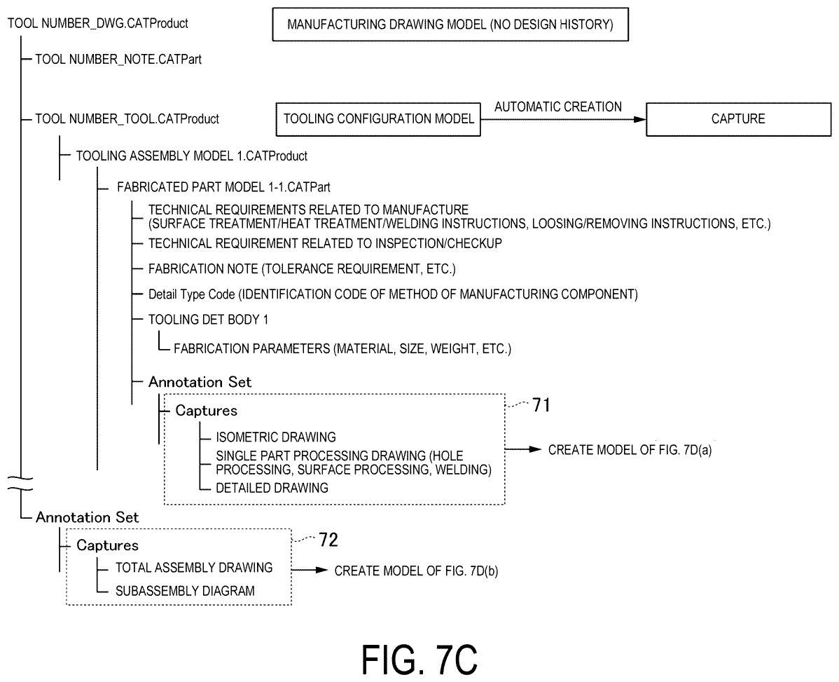

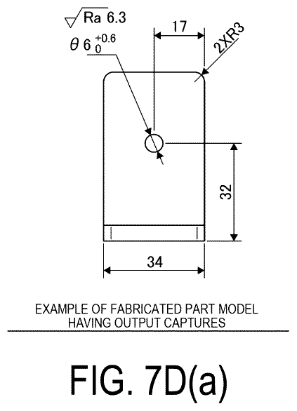

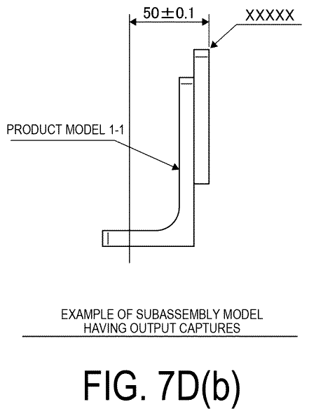

Next, processing of creating a BOM from the manufacturing drawing model will be described with reference to FIGS. 7A and 7B. As illustrated in FIG. 7A, the tooling configuration model (TOOL.CATProduct) of the manufacturing drawing model includes technical requirements related to manufacture such as a surface treatment instruction, a heat treatment instruction, and a welding instruction, a technical requirement related to inspection/checkup, a fabrication note such as a tolerance requirement, manufacturing parameters such as a material, a size, and a weight, and, when a component of the tooling is a purchased part, information such as a vendor, a model number, a name, and a quantity of the component. Here, when the tooling designer performs a predetermined operation, the BOM creation unit 15 extracts information necessary for arranging a component constituting the tooling from the tooling configuration model data of the manufacturing drawing model, creates a BOM, and outputs the BOM to an electronic file or the like. FIG. 7B illustrates an example of the output BOM. DET.No is an identifier of each component, and list information including information such as a model number, a name, and a quantity of each component is output. The BOM may include, in addition to a list of arranged parts, technical requirements such as designation of surface roughness, heat treatment condition, heat treatment hardness, necessity of surface treatment, necessity of welding, and necessity of material inspection and hardness inspection. The BOM and the tooling configuration model (including the three-dimensional model of the tooling) are given to, for example, the tooling manufacturer. The tooling manufacturer arranges a component based on the BOM and fabricates the tooling with reference to a tooling shape, a geometric dimensional tolerance, and a fabrication instruction and the like using a capture (a method of displaying information such as a geometric dimensional tolerance, an individual technical requirement, and a processing method in a balloon-like form at a target portion of the three-dimensional model), which are provided by the manufacturing drawing model.

Next, processing of creating a capture from the manufacturing drawing model will be described with reference to FIGS. 7C, 7D(a), and 7D(b). As illustrated in FIG. 7C, in an annotation set immediately subordinate to the fabricated part model 1-1. CATPart, captures 71 are registered which includes single tooling processing information such as an isometric drawing, a single part processing drawing in which instructions about hole processing, surface processing, welding, and the like are written, and a detailed drawing. In an annotation set immediately subordinate to the manufacturing drawing model (DWG.CATProduct), captures 72 including tooling assembly information such as a total assembly drawing and a subassembly drawing are registered. These pieces of information are registered by, for example, the tooling designer. Here, when the tooling designer performs a predetermined operation, the capture creation unit 16 creates captures from the captures 71 and the captures 72. For example, the capture creation unit 16 automatically creates the captures from the tooling configuration model data of the manufacturing drawing model using a dedicated macro or the like. The captures include a technical requirement related to manufacture, a technical requirement related to inspection/checkup, a fabrication note, and the like. FIG. 7D(a) illustrates examples of the captures created from the captures 71, and FIG. 7D(b) illustrates examples of the captures created from the captures 72. At a fabrication site, various work instructions about welding work, assembly work, and the like are necessary from the viewpoint of workability. In general, the work instructions are created separately from the model. Thus, it is likely to require time and effort in design work and cause mismatching with drawings. On the other hand, in the present embodiment, both a CAD model of a component and the like and work instruction information are defined and managed on a model basis. As a result, as illustrated in FIG. 7C, in the manufacturing drawing model (DWG.CATProduct), various technical instructions such as instructions about a shape to a specification, a geometric dimensional tolerance, and processing instructions about welding, surface treatment, and the like, can be defined for a single part and an assembled part. Then, these pieces of technical information can be automatically output as captures (for example, FIGS. 7D(a) and 7D(b)). The captures can be output in a non-CAD format such as a format of an image or PDF. The captures can be output not only from the tooling configuration model (TOOL.CATProduct) but also from the tooling manual model (DREF.CATProduct) or the inspection/checkup model (INSP.CATProduct). As for the tooling configuration model, examples of information output as the captures include a geometric dimensional tolerance (geometric dimensioning and tolerancing (GD & T)), an instruction about additional processing, a welding instruction (balloon drawing), an assembly drawing (assembly) instruction, an instruction about set dimensions and inspection dimensions, and instructions about surface treatment, painting, and stamping. The captures of the tooling manual model include an instruction about a component to be attached or detached, an instruction about a method of using a component to be shared, a manual drawing, and the like. The captures of the inspection/checkup model include a guideline for a test such as a load test, an inspection/checkup instruction, and the like. At the time of arrangement and fabrication (assembly), the tooling can be smoothly arranged by using the output captures. In addition, at the time of a load test or a quality inspection, the test or the like can be smoothly performed with reference to the captures. In a manner similar to the BOM, by setting links with various models such as the tooling configuration model, the captures are automatically updated when the engineering model is changed. In the design procedure, after the design is completed, the captures and the BOM are simultaneously output, used together for arranging the tooling, and developed to the tooling manufacturer. The tooling manufacturer arranges a component based on the BOM, and fabricates the tooling with reference to the fabrication instruction or the like using the captures.

With such a mechanism, the manufacturing drawing model and the BOM for arranging the tooling in advance can be created in conjunction with aircraft body design, and a change in the engineering model can be quickly reflected in the manufacturing drawing model and the BOM. Thus, it is possible to start manufacturing the tooling in an early stage after the initial design of the engineering model (or may be in the middle of the design), and to reduce the development lead time of the aircraft including the tooling. When a drawing is revised during arrangement, it is possible to easily recognize addition, specification change and deletion of a component to be arranged and quickly review the arrangement by comparing new and old BOMs. In addition, by comparing old and new captures, it is possible to quickly check and examine a change point of the work.

### Operation

An operation of the tooling model creation device 10 of the present embodiment will be described.

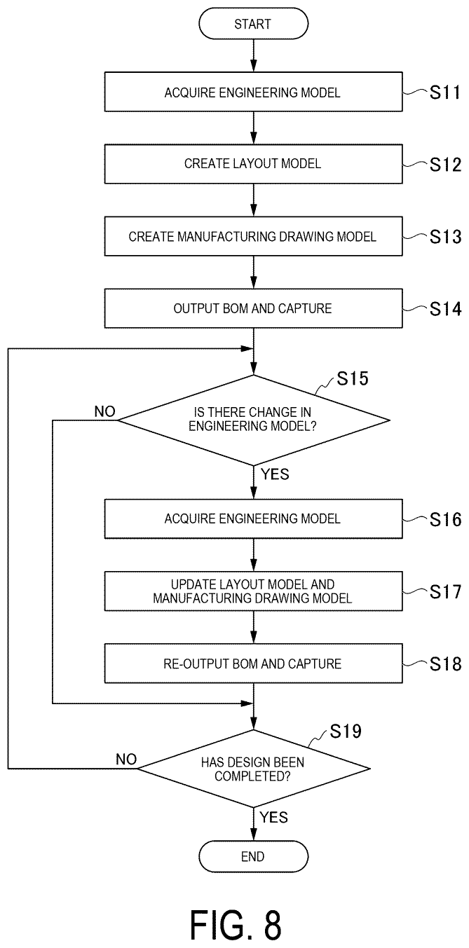

FIG. 8 is a flowchart illustrating an example of an operation of the tooling model creation device according to the embodiment.

First, the designer creates an engineering model. The engineering model acquisition unit 12 acquires the created engineering model (step S11) and stores the engineering model in the storage unit 18. Next, the tooling designer link-copies the engineering model in the storage unit 18 and creates a layout model (step S12). For example, the tooling designer creates the layout model by link-copying a part of the engineering model related to target tooling using the layout model creation unit 13 (CAD software). Based on an operation by the tooling designer, the output unit 17 outputs the layout model to a display device or the like. The tooling designer designs the tooling necessary for manufacturing the aircraft body part with reference to the link-copied engineering model. In addition, the tooling designer performs settings of a related facility and a related tooling necessary for manufacturing the tooling, definition of a positional relationship with respect to a reference surface, a correction surface, and an aircraft body, link settings, and the like. When the tooling designer performs the design and settings, the layout model creation unit 13 stores each piece of set information in the storage unit 18 as each element (LREF.CATProduct, RLM.CATProduct, TLM.CATProduct) of the tree configuration of the layout model described in FIG. 5.

Next, the tooling designer link-copies the layout model in the storage unit 18 and creates a manufacturing drawing model (step S13). For example, the tooling designer creates the manufacturing drawing model by link-copying the basic layout model (TLM.CATProduct) of the layout model using the manufacturing drawing model creation unit 14 (CAD software). The tooling designer sets information necessary for manufacturing the tooling (for example, the technical requirements illustrated in FIG. 7A) with reference to the link-copied basic layout model of the tooling. In addition, the tooling designer performs settings of a tooling assembly instruction, an inspection/checkup instruction, and the like. When the tooling designer performs the settings, the manufacturing drawing model creation unit 14 stores each piece of set information in the storage unit 18 as each element (NOTE.CATPart, TOOL.CATProduct, DREF.CATProduct, INSP.CATProduct) of the tree configuration of the manufacturing drawing model described in FIG. 5. Next, when the tooling designer performs a predetermined operation, the BOM creation unit 15 extracts a component of the tooling from the tooling configuration model (TOOL.CATProduct) of the manufacturing drawing model, and outputs the component as the BOM through the output unit 17 (step S14). Further, the capture creation unit 16 creates a capture from the tooling configuration model (TOOL.CATProduct) and the like, and outputs the capture (for example, FIGS. 7D(a) and 7D(b)) through the output unit 17 (step S14). The tooling designer gives the tooling configuration model, the BOM, and the capture to the tooling manufacturer and requests manufacture of the tooling. In this case, it is possible to start manufacturing the tooling at an early stage.

Alternatively, the output unit 17 may automatically transmit the created BOM and capture to a system of the tooling manufacturer, for example. Further, the system of the tooling manufacturer may be configured such that when the BOM is output from the tooling model creation device 10, the type and quantity of a component not in stock are checked and the component is automatically ordered in conjunction with an inventory management system or an ordering system. Tooling manufacture and inspection in the related art require a detailed instruction using a paper drawing or 2D drawing. Moreover, in the related art, there are complicated instructions about a bolt and a small constituent part specific to aircraft tooling, but data is not managed for each constituent part (bolt or the like) for simplification of tooling design and manufacturing work, unlike an aircraft body drawing. Thus, there is a lot of manual work for creating a BOM, such as arranging a component without preparing the BOM. On the other hand, according to the present embodiment, the specification and technical instruction for large-scale tooling for manufacturing the aircraft are defined on a model basis. Thus, it is possible to automatically create the BOM and the capture while suppressing an increase in work man-hours of the design. The BOM for arranging the tooling in advance can be created in conjunction with the aircraft body design, and thus it is possible to start manufacturing the tooling at an early stage, and reduce the development lead time of the aircraft. Information related to the tooling design and manufacture can be managed based on the layout model and the manufacturing drawing model without using a paper or 2D drawing, which can clarify the authority of the drawings and reduce the management cost of the design work and design data. By automatically creating the BOM, the tooling cost can be finely managed, and by directly arranging a necessary component using the BOM, work for arranging the tooling can be simplified. Further, the technical requirements and work instructions necessary for manufacturing and testing the tooling are registered and managed on the tooling configuration model, and are output as the captures together with the BOM, which can improve the efficiency of manufacturing the tooling.

Next, it is determined whether or not there is a change in the engineering model (step S15). When there is no change (No in step S15), the processing proceeds to step S19. When there is a change in the engineering model (Yes in step S15), the engineering model acquisition unit 12 acquires a changed engineering model (step S16). Next, the layout model and the manufacturing drawing model are updated based on the changed engineering model (step S17). For example, the tooling designer reads out the layout model using the layout model creation unit 13, performs a predetermined operation, and reflects the change in the engineering model in the layout model. As a result, the change is reflected in the engineering model (ENG.CATProduct) of the layout model link-copied from the engineering model, the facility information/related tooling model (LREF.CATProduct) and the related design model (RLM.CATProduct) linked with the engineering model of the layout model are updated, and the basic layout model (TLM.CATProduct) linked with the related design model is updated. In addition, the tooling designer reads out the manufacturing drawing model using the manufacturing drawing model creation unit 14, performs a predetermined operation, and reflects the change in the layout model in the manufacturing drawing model. Thus, the tooling configuration model (TOOL.CATProduct) of the manufacturing drawing model linked with the basic layout model of the layout model is updated. When design information or the like affected by the change in the engineering model is reflected in the manufacturing drawing model, the BOM creation unit 15 re-creates a BOM from the changed manufacturing drawing model again and re-outputs the BOM through the output unit 17 (step S18). At this time, in addition to the changed BOM, the BOM creation unit 15 may automatically create a comparison table of the old and new BOMs in which the BOMs before and after the change are compared. In addition, the capture creation unit 16 re-creates a capture from the changed manufacturing drawing model and re-outputs the capture through the output unit 17 (step S18). At this time, the capture creation unit 16 may create a comparison table of the old and new captures. The tooling designer gives the tooling configuration model and the re-output BOM and capture that reflect the change in the engineering model to the tooling manufacturer to notify the tooling manufacturer of the change of the tooling. Alternatively, the output unit 17 may transmit the created BOM, comparison table of the new and old BOMs, capture, and comparison table of the new and old captures to the system of the tooling manufacturer. In this case as well, a configuration may be adopted in which the comparison table of the new and old BOMs works in conjunction with the inventory management system and the ordering system, and cancellation of a changed component and additional ordering are automatically performed. By updating the shape and specification definition according to the design phase of the aircraft body and updating the BOM each time in this way, it is possible to manufacture the tooling in parallel with the tooling design. Next, it is determined whether or not the design of the aircraft has been completed (step S19). When the design has been completed (Yes in step S19), the processing of FIG. 8 ends. When the design has not been completed (No in step S19), the processing in and after step S15 is repeatedly executed.

### Effects

As described above, according to the manufacturing drawing model creation method of the present embodiment, it is possible to quickly design tooling and create a component list (BOM) necessary for manufacturing the tooling in response to a design change of an aircraft body. Thus, the tooling can be designed and manufactured in conjunction with aircraft body design, which can reduce the development lead time of an aircraft.

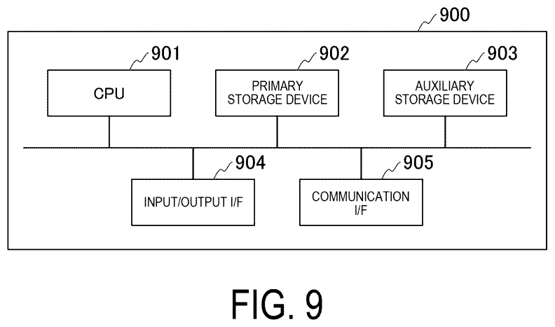

FIG. 9 is a diagram illustrating an example of a hardware configuration of the tooling model creation device 10 according to the embodiment. A computer 900 includes a CPU 901, a primary storage device 902, an auxiliary storage device 903, an input/output interface 904, and a communication interface 905. The tooling model creation device 10 described above is implemented in the computer 900. Each of the above-described functions is stored in the auxiliary storage device 903 in a format of a program. The CPU 901 reads the program from the auxiliary storage device 903, loads the program into the primary storage device 902, and executes the above-mentioned processing in accordance with the program. The CPU 901 secures a storage area in the primary storage device 902 in accordance with the program. The CPU 901 secures a storage area for storing data under processing in the auxiliary storage device 903 in accordance with the program.

A program for implementing all or some of the functions of the tooling model creation device 10 may be recorded in a computer readable recording medium, and a computer system may be caused to read and execute the program recorded in the recording medium to execute the processing of respective functional units. The “computer system” here includes an operating system (OS) and hardware such as peripheral equipment. If a WWW system is used, the “computer system” also includes a home page providing environment (or a display environment). The “computer readable recording medium” refers to a portable medium such as a CD, a DVD, or a USB device, or a storage device such as a hard disk built in the computer system. When this program is distributed to the computer 900 through a communication line, the computer 900 having received the distributed program may load the program into the primary storage device 902 and may execute the above-mentioned processing. The above-described program may implement some of the functions described above, and furthermore, also implement the functions described above in combination with a program already recorded in the computer system.

Some embodiments according to the disclosure have been described as above, these embodiments are presented as mere examples, and are not intended to limit the scope of the disclosure. These embodiments may be implemented in various other forms, and various omissions, substitutions, and changes can be made without departing from the gist of the disclosure. These embodiments and modifications thereof are included in the scope and gist of the disclosure and are also included in the scope of the disclosure described in the claims and the equivalents thereof.

### Supplementary Notes

The tooling model creation device, the tooling model creation method, and the program described in the embodiment can be understood as follows, for example.

(1) A tooling model creation device according to a first aspect includes a unit configured to create, based on an engineering model that is design information on a completed aircraft body of an aircraft, a layout model including design information on a piece of tooling necessary for manufacturing the aircraft body, and a unit configured to extract the design information on the piece of tooling from the layout model and create a manufacturing drawing model in which information necessary for manufacturing the piece of tooling is added to the design information on the piece of tooling.

Thus, it is possible to efficiently design and manufacture the piece of tooling in conjunction with the design of the engineering model.

(2) A tooling model creation device according to a second aspect is the tooling model creation device according to (1) and further includes a unit configured to extract list information on a component necessary for manufacturing the piece of tooling from the manufacturing drawing model and create a BOM including the extracted list information.

Thus, the BOM for manufacturing the piece of tooling can be created. By utilizing the created BOM, the piece of tooling can be efficiently arranged.

(3) A tooling model creation device according to a third aspect is the tooling model creation device according to (1) to (2), wherein the manufacturing drawing model includes the information necessary for manufacturing the piece of tooling, information on a method of using the piece of tooling, and inspection information for defining an inspection criterion to be satisfied by the piece of tooling.

Thus, the piece of tooling can be manufactured, used, and inspected.

(4) A tooling model creation device according to a fourth aspect is the tooling model creation device according to (1) to (3), wherein the information necessary for manufacturing the piece of tooling further includes work instruction information related to the manufacturing of the piece of tooling, the work instruction information being necessary at a manufacturing site, and the tooling model creation device further includes a unit configured to extract the work instruction information from the manufacturing drawing model and create capture information for displaying the extracted work instruction information together with a drawing of a component that is a target of the work instruction information.

Thus, the capture can be created. By utilizing the created capture, it is possible to improve work efficiency at the manufacturing site of the piece of tooling.

(5) A tooling model creation device according to a fifth aspect is the tooling model creation device according to (1) to (4), wherein the unit creating the layout model creates the layout model, the layout model including first data that is copied to the layout model in such a manner that a change made to the engineering model is reflected in data into which the engineering model is to be copied, and the second data in which a change made to the first data is reflected, and the unit creating the manufacturing drawing model creates the manufacturing drawing model based on third data copied to the manufacturing drawing model in such a manner that a change made to the layout model is reflected in data into which the layout model is to be copied.

Thus, it is possible to manage the layout model and the manufacturing drawing model while maintaining a link with the engineering model. In addition, by copying and including the necessary information, it is possible to reduce the effort for model creation.

(6) A tooling model creation device according to a sixth aspect is the tooling model creation device according to (5), wherein the unit creating the layout model creates, as the second data, position information on the piece of tooling having a predetermined positional relationship with a part of the aircraft body in the engineering model.

Thus, even when the position of the engineering model is changed, the change can be reflected in the position of the piece of tooling in the layout model.

(7) A tooling model creation device according to a seventh aspect is the tooling model creation device according to (5) to (6), wherein when a change is made to the engineering model, the unit creating the layout model reflects, with reference to the engineering model, the change in the engineering model in the first data, the first data being copied in such a manner that a change in the engineering model is reflected, and updates the second data based on the changed first data.

Thus, the change in the engineering model can be reflected in the layout model.

(8) A tooling model creation device according to an eighth aspect is the tooling model creation device according to (5) to (7), the unit creating the manufacturing drawing model excludes information on design histories of the aircraft body and the piece of tooling and extracts, from the layout model, only the design information on the piece of tooling which is final design information.

Thus, it is possible to prevent leakage of confidential information and know-how.

(9) A tooling model creation device according to a ninth aspect is the tooling model creation device according to (2) to (8), wherein when a change is made to the engineering model, the unit creating the BOM creates a BOM from the manufacturing drawing model created after the change of the engineering model, and the unit creating the BOM creates an old and new comparison table of the BOM which compares a BOM created from the manufacturing drawing model before the change and a BOM created from the manufacturing drawing model after the change.

Thus, it is possible to recognize the change point of the BOM and quickly review the arrangement.

(10) A manufacturing drawing model creation method according to a tenth aspect includes creating, based on an engineering model that is design information on a completed aircraft body of an aircraft, a layout model including design information on a piece of tooling necessary for manufacturing the aircraft body, and extracting the design information on the piece of tooling from the layout model and creating a manufacturing drawing model in which information necessary for manufacturing the piece of tooling is added to the design information on the piece of tooling.

(11) A program according to an eleventh aspect causes a computer to execute creating, based on an engineering model that is design information on a completed aircraft body of an aircraft, a layout model including design information on a piece of tooling necessary for manufacturing the aircraft body, and extracting the design information on the piece of tooling from the layout model and creating a manufacturing drawing model in which information necessary for manufacturing the piece of tooling is added to the design information on the piece of tooling.

While preferred embodiments of the disclosure have been described as above, it is to be understood that variations and modifications will be apparent to those skilled in the art without departing from the scope and spirit of the disclosure. The scope of the disclosure, therefore, is to be determined solely by the following claims.

1. A tooling model creation device comprising:
a unit configured to create, based on an engineering model that is design information on a completed aircraft body of an aircraft, a layout model including design information on a piece of tooling necessary for manufacturing the aircraft body; and
a unit configured to extract the design information on the piece of tooling from the layout model and create a manufacturing drawing model in which information necessary for manufacturing the piece of tooling is added to the design information on the piece of tooling.

2. The tooling model creation device according to claim 1, further comprising:
a unit configured to extract list information on a component necessary for manufacturing the piece of tooling from the manufacturing drawing model and create a BOM including the extracted list information.

3. The tooling model creation device according to claim 1, wherein
the manufacturing drawing model includes the information necessary for manufacturing the piece of tooling, information on a method of using the piece of tooling, and inspection information for defining an inspection criterion to be satisfied by the piece of tooling.

4. The tooling model creation device according to claim 3, wherein
the information necessary for manufacturing the piece of tooling further includes work instruction information related to the manufacturing of the piece of tooling, the work instruction information being necessary at a manufacturing site, and
the tooling model creation device further includes a unit configured to extract the work instruction information from the manufacturing drawing model and create capture information for displaying the extracted work instruction information together with a drawing of a component that is a target of the work instruction information.

5. The tooling model creation device according to claim 1, wherein
the unit creating the layout model creates the layout model, the layout model including first data that is copied to the layout model in such a manner that a change made to the engineering model is reflected in data into which the engineering model is to be copied, and the second data in which a change made to the first data is reflected, and
the unit creating the manufacturing drawing model creates the manufacturing drawing model based on third data copied to the manufacturing drawing model in such a manner that a change made to the layout model is reflected in data into which the layout model is to be copied.

6. The tooling model creation device according to claim 5, wherein
the unit creating the layout model creates, as the second data, position information on the piece of tooling having a predetermined positional relationship with a part of the aircraft body in the engineering model.

7. The tooling model creation device according to claim 5, wherein
when a change is made to the engineering model, the unit creating the layout model reflects, with reference to the engineering model, the change in the engineering model in the first data, the first data being copied in such a manner that a change in the engineering model is reflected, and updates the second data based on the changed first data.

8. The tooling model creation device according to claim 5, wherein
the unit creating the manufacturing drawing model excludes information on design histories of the aircraft body and the piece of tooling and extracts, from the layout model, only the design information on the piece of tooling which is final design information.

9. The tooling model creation device according to claim 2, wherein
when a change is made to the engineering model, the unit creating the BOM
creates a BOM from the manufacturing drawing model created after the change of the engineering model, and
creates an old and new comparison table of the BOM which compares a BOM created from the manufacturing drawing model before the change and a BOM created from the manufacturing drawing model after the change.

10. A tooling model creation method performed by a computer, the tooling model creation method comprising:
creating, based on an engineering model that is design information on a completed aircraft body of an aircraft, a layout model including design information on a piece of tooling necessary for manufacturing the aircraft body; and
extracting the design information on the piece of tooling from the layout model and creating a manufacturing drawing model in which information necessary for manufacturing the piece of tooling is added to the design information on the piece of tooling.

11. A non-transitory computer readable storage medium storing a program for causing a computer to execute:
creating, based on an engineering model that is design information on a completed aircraft body of an aircraft, a layout model including design information on a piece of tooling necessary for manufacturing the aircraft body; and
extracting the design information on the piece of tooling from the layout model and creating a manufacturing drawing model in which information necessary for manufacturing the piece of tooling is added to the design information on the piece of tooling.
